(19) United States
(12) Patent Application Publication
(10) Pub. No.: US 2015/0111753 A1
(43) Pub. Date: Apr. 23, 2015

(54) SUPERCONDUCTING MAGNET APPARATUS

(71) Applicant: Hitachi, Ltd., Tokyo (JP)

(72) Inventors: Ryoji NAKAGAWA, Tokyo (JP); Ryuya ANDO, Tokyo (JP); Manabu AOKI, Tokyo (JP)

(21) Appl. No.: 14/513,710

(22) Filed: Oct. 14, 2014

(30) Foreign Application Priority Data
Oct. 17, 2013 (JP) 2013-215943

(51) Int. Cl. H01F 6/04; H01F 27/28; H01F 6/02; H01F 6/06

(52) U.S. Cl. CPC H01F 6/04; H01F 6/06; H01F 27/28; H01F 6/02; F17C 13/001
USPC 505/163; 62/51.1

(57) ABSTRACT

A superconducting magnet apparatus is provided, which comprises a superconducting coil, an induction coil to be in inductive coupling with the superconducting coil, a first refrigerant vessel charged with a first refrigerant in which the superconducting coil is installed; and a second refrigerant vessel charged with a second refrigerant having a melting temperature higher than or a boiling temperature higher than a boiling temperature of the first refrigerant, the second refrigerant vessel in which the induction coil is installed, wherein the second refrigerant vessel is thermally isolated from the first refrigerant vessel.

### FIELD OF INVENTION

The present invention relates to a superconducting magnet apparatus equipped with a superconducting coil.

### BACKGROUND OF INVENTION

A circuit used for the superconducting magnet apparatus comprises, for example, a superconducting coil, an excitation power source for supplying a current to the superconducting coil and a persistent current switch. The superconducting coil and the persistent current switch are installed in a cryostat having a capability for cooling for maintaining superconductivity.

This superconducting magnet apparatus is configured to start persistent current mode operation by having the excitation power source supply current to the superconducting coil while the persistent current switch is kept on and subsequently having the excitation power source stop supplying current to the superconducting coil on the persistent current switch being switched off, and be able to continue the persistent current operation of having the current continuously flow without attenuating through a closed circuit constituted by the superconducting coil and the persistent current switch. This superconducting magnet apparatus is able to keep a magnet field induced by carrying out this persistent current mode operation for a long period.

When superconducting-to-normal transition occurs at a portion of the superconducting coil, there is a resistance created at the portion. When the resistance is created, magnet energy (stored magnet energy) stored in the superconducting coil is converted to thermal energy through Joule heat generation and a temperature of the portion of the superconducting coil rises. As a result, other portion at which superconducting-to-normal transition has not occurred is transitioned from the superconducting state to the normal state as heat is transmitted from the portion of the superconducting coil where the resistance is first created to the other portion of the superconducting coil. In this way, the superconducting-to-normal transition occurs sequentially across the whole superconducting coil. As a result, a phenomenon (called a quench phenomenon) can occur in which the magnetic field created by the superconducting coil has gone. When the quench phenomenon occurs, the stored magnetic energy in the superconducting coil is converted to the thermal energy.

The superconducting coil has to be kept cooled at a temperature that is not higher than a predetermined temperature to maintain its superconducting state. If the superconducting coil is dipped in a refrigerant for cooling, the refrigerant vaporizes and is consumed due to the heat generated on the quench phenomenon occurring. Therefore, when such a refrigerant as liquid helium is used, it is desirable to inhibit the refrigerant from vaporizing and consume as small an amount of the refrigerant as possible.

There is a known method of installing an induction coil at a position where the induction coil is thermally isolated from and to be in strong inductive coupling with the superconducting coil installed in a refrigerant vessel. This method is a prior art technique to inhibit the refrigerant from being consumed and is disclosed, for example, by JP08-051014A. According to this method, when the magnetic field attenuates on a quench occurring, a current is induced in the induction coil and it is possible to have the magnetic energy in the superconducting coil consumed outside the refrigerant vessel through the Joule heat generation in the induction coil.

However, when the magnet energy is consumed through the induction coil, the temperature of the induction coil rises significantly due to the Joule heat generation. In general, since a good conductor of which the induction coil is made has a resistivity which becomes higher with the temperature of the coil becoming higher, the resistance of the induction coil gradually becomes higher after a quench occurs. On the other hand, in order to transfer to the induction coil as much energy as possible, the induction coil ought to have as low a resistance as possible for a large current to be able to flow through the induction coil.

The superconducting magnet apparatus of JP08-051014A is not equipped with a mechanism to keep the induction coil cooled when a quench occurs, the resistance of the induction coil rises after the quench and an amount of energy transferred. Accordingly, part of energy in the superconducting magnet is consumed on the Joule heat generation of the superconducting coil.

In addition, an amount of energy generated for a unit time when a quench occurs is much more than a cooling capability for a unit time by a cooling apparatus and it is difficult to keep the induction coil at low temperatures using the cooling apparatus.

The present invention is intended to provide a superconducting magnet apparatus that is capable of inhibiting the temperature rise of the induction coil when a quench occurs, inhibiting decrease in an amount of energy transferred to the induction coil and inhibiting consumption of the refrigerant for the superconducting coil.

In order to achieve the objective above mentioned, a superconducting magnet apparatus of an embodiment of the present invention comprises a superconducting coil, a first refrigerant vessel charged with a first refrigerant, the first refrigerant vessel in which the superconducting coil and an induction coil to be in inductive coupling with superconducting coil are disposed, and a second refrigerant vessel charged with a second refrigerant having a boiling temperature higher than a boiling temperature of the first refrigerant, the second refrigerant vessel in which the induction coil is installed, wherein the second refrigerant vessel is thermally isolated from the first refrigerant vessel.

The present invention contributes to inhibiting decrease in an amount of energy transferred to the induction coil and inhibiting consumption of the refrigerant for the superconducting coil.

### BRIEF DESCRIPTION OF DRAWINGS

FIG. 1 is a circuit diagram for a superconducting magnet apparatus of the first embodiment.

FIG. 2 is a schematic cross section view of the superconducting magnet apparatus of the first embodiment.

FIG. 3 is a schematic cross section view of the superconducting magnet apparatus of a second embodiment.

FIG. 4 is a schematic cross section view of the superconducting magnet apparatus of a third embodiment.

FIG. 5 is a circuit diagram for a superconducting magnet apparatus of a fourth embodiment.

FIG. 6 is a circuit diagram for a superconducting magnet apparatus of a modified embodiment of the fourth embodiment.

### DETAILED DESCRIPTION OF EMBODIMENTS

Embodiments for practicing the present invention are explained in detail hereinafter with reference to the attached figures. It should be noted that a single sign is attached to an identical part or a identical portion indicated in more than one figure and that no duplicated explanation is given on the identical part or portion.

### First Embodiment

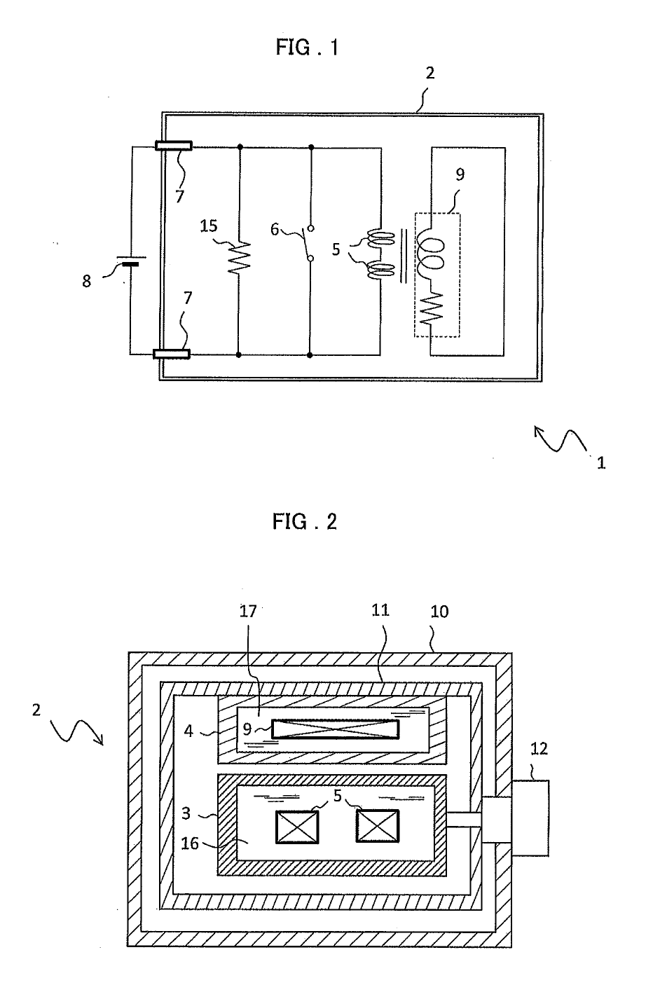

FIG. 1 is a circuit diagram for a superconducting magnet apparatus of the first embodiment. A superconducting magnet apparatus 1 comprises a cryostat 2 and an excitation power source 8 installed outside the cryostat 2. Inside the cryostat 2 are installed a plurality of superconducting coils 5 (there are 2 in FIG. 1), a persistent current switch 6, an induction coil 9 and a protection resistor 15.

The superconducting coil 5 and the persistent current switch 6 are connected in series with each other through a superconducting wire. Both terminals of the protection resistor 15 are connected with both output terminals of the excitation power source 8 and there are a couple of current passages formed between the excitation power source 8 and the persistent current switch 6. There is a current lead 7 interposed in each of these current passages and this current lead is capable of being taking off from the cryostat 2. The induction coil 9 is to be in strong inductive coupling with the superconducting coil 5 and constitutes a closed circuit on its own. In order to make an inductive coupling between the induction coil 9 and the superconducting coil 5 larger, the induction coil 9 and the superconducting coil 5 are arranged to have an identical center axis and have an offset space between them as small as possible.

FIG. 2 is a schematic cross section view of the cryostat 2 of the superconducting magnet apparatus of the first embodiment.

The cryostat 2 comprises a refrigerant vessel 3 that is a first refrigerant vessel, a refrigerant vessel 4 that is a second refrigerant vessel, a vacuum vessel 10 for vacuum heat isolation, a radiation shield 11 to inhibit radiated heat coming in and a refrigerating machine 12. Both the refrigerant vessel 3 and the refrigerant vessel 4 are disposed inside the radiation shield 11, which is disposed inside the vacuum vessel 10. The superconducting coil 5 and the persistent current switch 6 (not shown in FIG. 2) are disposed in the refrigerant vessel 3. The refrigerant vessel 3 is charged with a refrigerant 16 (for example, liquid helium) that is a first refrigerant 16, and the superconducting coil 5 and the persistent current switch 6 are kept in the superconducting state. The induction coil 9 is disposed inside the refrigerant vessel 4. The refrigerant vessel 4 is charged with the refrigerant 17 (for example, liquid nitrogen) which is a second refrigerant whose boiling temperature is higher than that of the first refrigerant to keep the induction coil 9 cooled.

The refrigerant machine 12 is capable of cooling an object to a couple of set temperatures. That is, the refrigerant machine 12 includes a couple stages, a first stage with which a cooled object is cooled to a first set temperature and a second stage with which the cooled object is cooled to a second set temperature.

The second stage is intended to cool the cooled object to the second set temperature which is lower than the first set temperature on the first stage and thermally coupled with the refrigerant vessel 3. The first stage is thermally coupled with the refrigerant vessel 4 and the radiation shield 11. Refrigerants in the refrigerant vessel 3 and the refrigerant vessel 4 are cooled by refrigerating machine 12 and kept in the liquid state. It should be noted that the couple of stages do not have to have the different set temperatures from each other and that the cooled object may be cooled instead to the second set temperature through the refrigerant 17 in the first stage.

Next, an operation of the superconducting magnet apparatus 1 is explained with reference to FIG. 1. Firstly, the current leads 7 are connected with the cryostat 2 to have the excitation power source 8 supply a current to the superconducting coil 5 while the persistent current switch 6 is kept open (off, that is, normal state). The supplied current to the super conducting coil 5 is set within a range in which the current flowing through the induction coil 9 is not too large. After the supplied current increases to a predetermined current, the persistent current switch 6 is closed (switched on, that is, superconducting state). Secondly, the current being supplied to the superconducting coil 5 stops being supplied from the excitation power source 8. Subsequently the current leads 7 are taken off from the cryostat 2 to prevent heat from being transmitted into the cryostat 2 from outside the cryostat 2.

When the current stops flowing from the excitation power source 8 to the superconducting coil 5, a current attenuation becomes so small over a closed circuit in which the superconducting coil 5 is connected in series with the persistent current switch 6 that is closed (switched on) that the superconducting magnet apparatus 1 is in operation with the persistent current. When the superconducting apparatus 1 is in such an operation as a persistent current operation, the superconducting apparatus 1 is able to keep a magnet field for a long time without a current being supplied from outside the cryostat 2.

Next is explained how a portion of the superconducting coil 5 becomes a normal state portion in the normal state and the normal state portion grows larger as the surrounding portion becomes the normal state portion (Quench phenomenon).

When the quench phenomenon occurs in the superconducting coil 5, an electrical resistance is generated in the superconducting coil 5. As the superconducting-to-normal transformation progresses, the resistance value of the superconducting coil 5 becomes larger and magnetic energy is consumed on Joule heat generation through this generated resistance. When the magnetic field generated by the superconducting coil 5 is attenuating due to the generated resistance, an electromotive force is induced by the changing magnetic field over the induction coil 9 that is in inductive coupling with the superconducting coil 5 and an induced current is made to flow through the induction coil 9. In other words, a part of magnetic energy which the superconducting coil 5 has is transferred to the induction coil 9. The magnetic energy transferred to the induction coil 9 is to be consumed on Joule heat generated in the refrigerant vessel 4 by the current flowing through an electrical resistance the induction coil 9 has.

Since the induction coil 9 is kept cooled by the refrigerant 17 with which the refrigerant vessel 4 is charged, the induction coil 9 remains at low temperatures when the induction coil 9 to which a part of magnetic energy of the superconducting coil 5 is transferred generates Joule heat, and the resistance increase of the induction coil 9 is inhibited. If the resistance increase of the induction coil 9 is inhibited, the induction coil 9 is kept in a condition in which a large current is able to flow through the induction coil 9 and an amount of magnetic energy to be transferred to the induction coil 9 does not decrease. In other words, the superconducting magnet apparatus 1 of the present embodiment is capable of inhibiting the decrease in the amount of magnetic energy to be transferred to the induction coil 9 due to the temperature rise of the induction coil 9.

The superconducting magnet apparatus 1 includes the refrigerant vessel 4 in addition to the refrigerant vessel 3 which houses the superconducting coil 5. The refrigerant vessel 4 houses the induction coil 9 that is to be in strong inductive coupling with the superconducting coil 5. When a portion of the superconducting coil 5 is transformed into the normal state, a part of magnetic energy the superconducting coil 5 has is transferred to the induction coil 9 and consumed on Joule heat generation by the induction coil 9. Since the induction coil 9 is kept cooled with the refrigerant 17, the resistance increase of the induction coil 9 due to the Joule heat generation is inhibited. Inhibiting the resistance of the induction coil 9 from increasing enables inhibiting the progressive decrease in the amount of the magnetic energy transferred from the superconducting coil 5 to the induction coil 9.

Furthermore, since an amount of magnetic energy consumed on the superconducting coil 5 is inhibited, the superconducting magnet apparatus 1 of the present embodiment is able to reduce an amount of the refrigerant 16 consumed on cooling the superconducting coil 5

### Second Embodiment

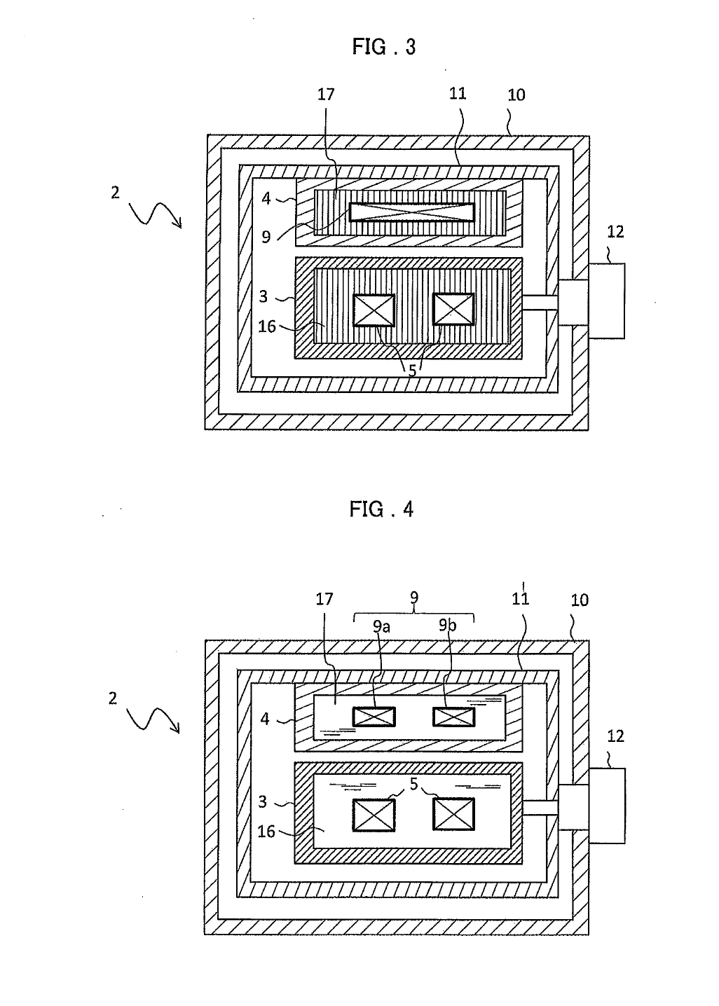

Next, a superconducting apparatus 1 of the second embodiment is explained. FIG. 3 is a schematic cross section view of a cryostat 2 according to a second embodiment. The superconducting magnet apparatus 1 of the second embodiment utilizes the refrigerant 17 of a solid refrigerant (for example, solid nitrogen or ice) whose melting temperature is higher than the boiling temperature of the refrigerant 16 with which the refrigerant vessel 3 is charged. The other configuration elements of the second embodiment are the same as those of the first embodiment and not explained.

The solid refrigerant can be cooled to a lower temperature than the liquid refrigerant, if the solid refrigerant is constituted by the same molecules as the liquid refrigerant. Therefore, as compared with the induction coil 9 of the first embodiment, the induction coil 9 of the second embodiment can be kept at a lower temperature. As a result, the induction coil has a lower resistance, which results in increasing magnetic energy transferred from the superconducting coil 5 to the induction coil 9.

As has been explained, since the superconducting magnet apparatus 1 of the second embodiment utilizes the solid refrigerant, the superconducting magnet apparatus 1 of the second embodiment has the same effect as the superconducting magnet apparatus 1 of the first embodiment has and additionally is able to transfer a larger amount of magnet energy from the superconducting coil 5 because the induction coil 9 can be kept cooled at a lower temperature.

### Third Embodiment

Next, the superconducting magnet apparatus 1 of the third embodiment is explained. FIG. 4 is a schematic cross section view of a cryostat 2 of the third embodiment. A configuration of the induction coil 9 of the third embodiment is different from those of the second and first embodiments. The other configuration elements of the third embodiments are the same as those of the first or the second embodiment and not explained.

The induction coil 9 of the third embodiment consists of a plurality coils (two coils 9a, 9b in FIG. 3). The plurality of coils constituting the induction coil 9 maybe connected in parallel or in series with each other and each of the plurality of coils constitutes a closed circuit of a closed loop. Since the induction coil 9 consists of a plurality of coils, the induction coil 9 has a larger surface area which helps increase a larger cooling effect. Therefore the superconducting magnet apparatus 1 of the third embodiment is able to efficiently reduce decrease in an amount of magnetic energy transferred from the superconducting coil 5 which results from the temperature rise of the induction coil 9 on occurrence of quench phenomenon.

Moreover, when the induction coil 9 consists of a plurality of coils, the induction coil 9 can be more freely disposed relative to the superconducting coil 5. If the induction coil 9 is disposed more freely, the induction coil 9 can be disposed in such a way that inductive coupling between the superconducting coil 5 and the induction coil 9 is stronger than that with the induction coil 9 of a single coil. Therefore a larger amount of magnetic energy can be transferred to the induction coil 9 of a plurality of coils than to the induction coil 9 of a single coil.

As has been explained, since the superconducting magnet apparatus 1 of the third embodiment has the induction coil 9 consisting of a plurality of coils, it has the same effect as the superconducting magnet apparatus 1 of the first or second embodiment does and additionally is able to inhibit decrease in magnetic energy transferred from the superconducting coil 9 due to the temperature rise of the induction coil 9 when the quench phenomenon occurs. In addition, since inductive coupling between the superconducting coil 5 and the induction coil 9 can be made stronger, a larger amount magnetic energy can be transferred to the induction coil 9.

### Fourth Embodiment

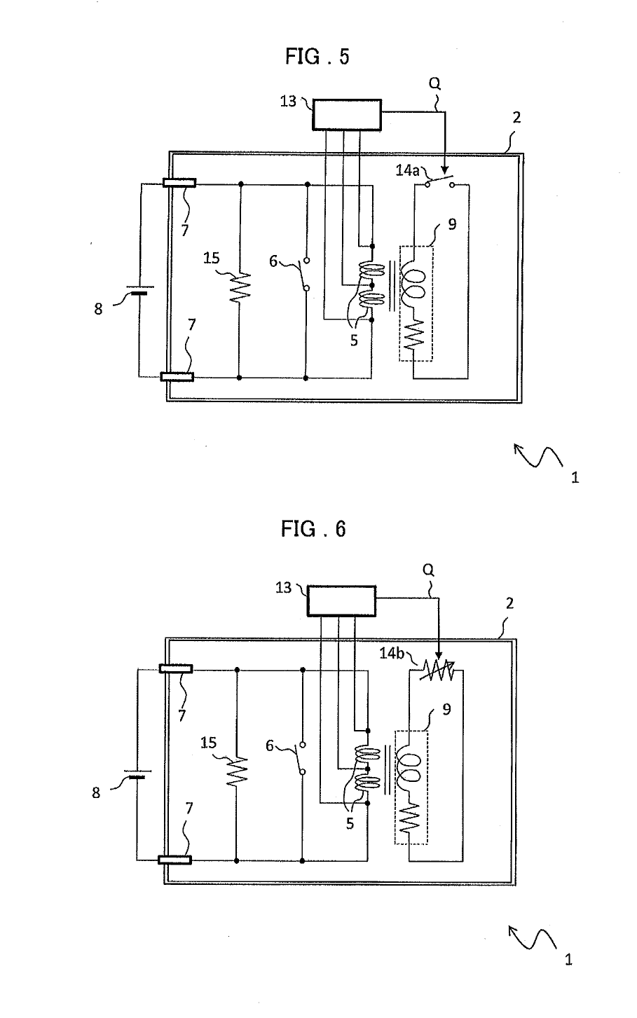

Next, the superconducting magnet apparatus 1 of the fourth embodiment is explained. FIG. 5 is a circuit diagram of the superconducting magnet apparatus 1 of the fourth embodiment. The superconducting magnet apparatus 1 of the fourth embodiment is different from those of the first to the third embodiments in that the superconducting magnet apparatus 1 of the fourth embodiment includes a quench detection unit 13 and a switching element 14a and has a different closed circuit inclusive of the induction coil 9 from those of the first to the third embodiments. The other configuration elements of the superconducting magnet apparatus 1 of the fourth embodiment are the same as those of the superconducting magnet apparatuses 1 of the first to the third embodiments and not explained.

The quench detection unit 13 is able to detect occurrence of a quench phenomenon by, for example, measuring a voltage on resistance over the superconducting coil 5. The switching element 14a and the induction coil 9 constitute a closed circuit.

The switching element 14a is, for example, a persistent current switch that performs switching operation below the boiling temperature of the refrigerant 17. The switching element 14a has a function of having the resistance over the closed circuit lowered when in a close state and being kept opened to have the resistance over the closed circuit high while a predetermined signal Q is being received.

The quench detection unit 13 may detect a temperature change of the superconducting coil 5 or an inside of the refrigerant vessel 3 or failure of the cooling machine 12 instead of the voltage on the resistance over the superconducting coil 5 for starting and stopping transmitting the predetermined signal Q.

As indicated in FIG. 6, a variable resistor 14b may be used instead of the persistent current switch for the switching element 14a. If the variable resistor 14b is used, the variable resistor 14b is controlled in such a way that the resistance of the variable resistor 14b becomes a first resistance value that is higher when the signal Q is transmitted by the quench detection unit 13 and changes to a second resistance value that is lower than the first resistance value when the quench detection unit 13 stops transmitting the signal Q.

While the superconducting magnet apparatus 1 is in the persistent current operation, the switching element 14a is kept in close state by the quench detection unit 13 and the circuit of the superconducting magnet apparatus 1 is substantially the same as those of the first to the third embodiments. In this case, the circuit inclusive of the induction coil 9 acts the same way as those of the first to the third embodiments when the quench occurs.

When the superconducting magnet apparatus 1 is magnetized or demagnetized, the quench detection unit 13 outputs the signal Q to the switching element 14a and the switching element 14a becomes in the open state in response to receiving the signal Q, which results in an induced current hardly flowing through the circuit inclusive of the induction coil 9. As should be understood, it is possible to inhibit magnet energy generated from a change in the magnetic field made when the superconducting coil 5 is magnetized or demaginetized from being transferred to the induction coil 9. As compared with the first to third embodiments, the superconducting magnet apparatus 1 of the present embodiment is able to more quickly magnetize and demagnetize the superconducting coil 5.

In addition, when superconducting-to-normal transition occurs, the superconducting apparatus 1 of the present embodiment is able to stop the quench detection unit 13 that detects the transition from transmitting the signal Q to the switching element 14a. When the switching element 14a becomes in the closed state, the superconducting magnet apparatus 1 has the circuit that is substantially the same as those of the first to the third embodiments and is able to transfer magnet energy of the superconducting coil 5 to the induction coil 9 and have the transferred magnet energy consumed by the circuit inclusive of the induction coil 9.

As has been explained, since the superconducting magnet apparatus 1 of the fourth embodiment comprises the quench detection unit 13 and the switching element 14a, it has the same effect as the superconducting magnet apparatuses 1 of the first to the third embodiments have and is able to more quickly perform magnetization or demagnetization.

What is claimed:

1. A superconducting magnet apparatus comprising;
a superconducting coil;
an induction coil to be in inductive coupling with the superconducting coil;
a first refrigerant vessel charged with a first refrigerant, in which the superconducting coil is installed; and
a second refrigerant vessel charged with a second refrigerant that has a melting temperature higher than or a boiling temperature higher than a boiling temperature of the first refrigerant, the second refrigerant vessel in which the induction coil is installed, wherein
the second refrigerant vessel is thermally isolated from the first refrigerant vessel.

2. The superconducting magnet apparatus as described in claim 1, wherein the second refrigerant is liquid.

3. The superconducting magnet apparatus as described in claim 1, wherein the second refrigerant vessel is charged with a solid refrigerant.

4. The superconducting magnet apparatus as described in claim 2, wherein the induction coil consists of a plurality of coils.

5. The superconducting magnet apparatus as described in claim 2, wherein a closed circuit inclusive of the induction coil consists of the induction coil.

6. The superconducting magnet apparatus as described in claim 2, further comprising;
a quench detection unit detecting superconducting-to-normal transition occurring in the superconducting coil, and
a switching element connected with the quench detection unit, the switching element and the induction coil constituting a closed circuit,
wherein the quench detection unit makes the switching element closed if the quench detection unit detects superconducting-to-normal transition of the induction coil when the quench detection coil is in operation and keeps the switching element opened when the induction coil is in a superconducting state.

7. The superconducting magnet apparatus as described in claim 2, further comprising;
a quench detection unit detecting superconducting-to-normal transition occurring in the superconducting coil, and
a variable resistor connected with the quench detection unit, the variable resistor and the induction coil constituting a closed circuit,
wherein if the quench detection unit detects superconducting-to-normal transition of the induction coil when the quench detection coil is in operation, the quench detection unit makes a resistance of the variable resistor lower than the resistance when the induction coil is in a superconducting state.

8. The superconducting magnet apparatus as described in claim 6, wherein the switching element consists of a persistent current switch that is able to operate at a temperature equal to or lower than a melting temperature or a boiling temperature of the second refrigerant.
